(19) United States
(12) Patent Application Publication
(10) Pub. No.: US 2025/0302008 A1
(43) Pub. Date: Oct. 2, 2025

(54) ANIMAL DENTAL HYGIENIC DEVICE WITH ELONGATED PORTION

(71) Applicants: Allan COOPERSMITH, Montreal (CA); Nathalie FISET, Montreal (CA)

(72) Inventors: Allan COOPERSMITH, Montreal (CA); Nathalie FISET, Montreal (CA)

(21) Appl. No.: 19/079,654

(22) Filed: Mar. 14, 2025

Related U.S. Application Data
(60) Provisional application No. 63/573,121, filed on Apr. 2, 2024.

(51) Int. Cl. A01K 15/02

(52) U.S. Cl. CPC A01K 15/026

(57) ABSTRACT

An animal dental hygienic device and method of its assembly are described. The device being orally attractive to an animal and including a body and a container having a cavity which may be empty or filled. The body and/or the container having openings that have dental-hygienically active dimensions, namely arranged and sized and dimensioned to approximate the median size, shape and arrangement of the teeth to be cleaned, such that the at least one aperture frictionally engages at least one of the outer surfaces of the tooth and gums of the animal during biting of the device by the animal and allowing for easy and rapid release and does not interfere with the opening of the animal's mouth. The device also provides increased cleaning by a coordinated cleaning relation between the parts of the device.

### RELATED APPLICATIONS

The present application claims priority from U.S. Provisional Application Ser. No. 63/573,121 filed on 2 Apr. 2024 and herein incorporated by reference in its entirety.

### FIELD

The present disclosure relates generally to animal dental hygienic devices. More particularly, the present disclosure relates to animal dental hygienic devices with one or more flexible portions suitable for cleaning animal teeth.

### BACKGROUND

Domesticated animals, such as cats and dogs, often need dental care to prevent dental problems commonly due to plaque, tartar, tooth decay, gingivitis, periodontal disease, and the like. Poor dental health in such animals is, unfortunately, very common. Indeed, periodontal disease is one of the most frequently treated diseases by veterinarians in the United States.

Most periodontal disease starts with the formation of a film of a soft amorphous biofilm called plaque, consisting primarily of oral bacteria, bacterial by-products, and oral debris. This film typically covers both the exposed tooth surface and the area lying under the gum line, the gingival cavity (sulcus). Through the deposition of calcium and other mineral salts, this layer of plaque may harden and develops into tartar. Although tartar is hard, it is also porous and adheres to the tooth surface. Tartar appears to be progressively deposited in layers and provides a rough surface onto which more plaque is deposited. As tartar builds up, a broad range of microbes and bacteria may attach. The by-products of metabolism from these bacteria cause inflammation of local tissues including those surrounding the gingival cavity. This ultimately leads to periodontal disease. The earliest stage is gingivitis, characterized by inflammation of the gums. As periodontal disease progresses, gingivitis becomes periodontitis, with inflammation extending into the connective tissues surrounding the tooth. Through gingivitis and periodontitis, it is thought that harmful bacteria enter into the blood stream and ultimately lodge in the heart and other internal organs.

In addition, the sides of the teeth facing the cheeks, i.e., the buccal (facial) side-located in the buccal cavity, have a greater incidence of gingivitis and plaque/tartar build-up than the sides of the teeth facing the tongue, i.e., the lingual (oral) side. It has also been found that the rear teeth, i.e., the pre-molars and molars, more rapidly develop plaque and tartar than the front teeth. These teeth are indeed the most difficult teeth for an animal owner to clean with a toothbrush.

The long-term impact of poor dental health may be devastating. Poor dental health is thought to be a contributing factor in the deaths of dogs, cats, and other mammals. In animals, as is the case in humans, poor dental health has been linked with serious diseases of the heart, liver, kidney, and other internal organs. Indeed, one study demonstrated that every dog with periodontal disease had pathological changes in the heart, liver, and kidneys.

Dental care for animals is generally more difficult to manage than dental care for humans. Animals hate to have their teeth brushed and do not voluntarily engage in tooth brushing resulting in 80% of pets over 2-3 years old having dental disease.

Some veterinarians recommend regularly brushing the animal's teeth, but as any pet owner knows, such a task is extremely difficult. It is often difficult for the owner to keep the animal's mouth open during brushing, and the process may be extremely unpleasant for the animal and even potentially dangerous to the owner. Few animal owners are willing and able to maintain this level of home care.

Another known solution is to bring the animal to the veterinarian to have it sedated and to have the veterinarian perform dental care on the animal while it is under sedation. This solution, however, is not something that may reasonably be performed daily, weekly or even monthly. Sedation may be potentially harmful to the animal, especially if the animal is older.

Many domestic animal dental hygienic devices have been created in the past. Also, many animal foods have been designed with the purpose of assisting in providing dental care to domestic animals as they eat. Conventionally, such foods are shaped as kibbles and have a texture adapted for abrading debris or tartar away from an animal's teeth as the animal chews. However, these domestic animal dental hygienic devices and foods do not propose satisfactory cleaning performances.

Specifically, typical conventional domestic animal hygienic products do not always clean the crevices of the animal's teeth, and many such products are ineffective in cleaning the areas underneath the animal's gums. In addition, typical conventional animal hygienic devices seemingly have limited efficacy in cleaning the molars and pre-molars, and this notwithstanding the fact that these are the teeth where tartar build up typically is heaviest. If an animal food or animal hygienic product is poorly designed, then, during chewing or biting, little of the food or part of the product will actually reach or travel around the rear buccal cavity, thus leading to reduced abrasive action and limited cleaning of the tooth surface.

A further drawback of typical conventional animal hygienic products is that many of these products are ineffective in removing existing tartar from the teeth. Because tartar is so hard, attempting to remove tartar by the simple abrading action caused by chewing on a food having a chewy material and an abrasive texture may not be effective in reducing the tartar.

A common failure of the typical conventional chew toys is that they are not designed to take into account the bite force exerted by the teeth and the biting behavior of the target animals. If the bite resistance is too high, then the teeth will not evenly penetrate the product and there will be little opportunity for the product to push further apically against the teeth and against or under the gums for cleaning in critical areas. Conversely, if the bite resistance is too low then the animal will rapidly bite through and potentially ingest the product; thus, little pressure will be exerted against the tooth surface and against or under the gums again leading to poor cleaning in critical areas.

In addition, there are dental chew toys existing that clean and scrape plaque and tartar to varying degrees, but they only clean in one or two dimensions.

Furthermore, the design of chew toys does not normally take the natural prey instinct into consideration. For instance, a cat will often carry its prey by the tail in its mouth.

Because none to date that provide satisfactory dental cleaning for animals are found in contemporary use, improvements in this area are therefore desirable.

The inventor has realized several facts that are believed to be helpful in designing improved animal hygienic devices.

It would be desirable that the oral hygiene device is cleaning the cervices (interdental spaces) of the animal's teeth, the molars, pre-molars, the gum and efficiently removing tartar thereof.

It would be desirable that the cleaning apparatus should be equally and preferably circumferentially, as in the case of a cat, distributed throughout the device and at the same time not compromise its strength and integrity by adding too many openings and/or interstitial spaces thereby reducing the remaining mass of material.

It would also be desirable that the oral hygiene device is cleaning circumferentially so that the animals tooth will be cleaned in any orientation the device is bitten or chewed.

Finally, it would be desirable that the oral hygiene device be as efficient, durable, affordable, attractive and engaging to animals as possible resembling an animal's natural prey to encourage interaction and engagement focusing on biting a form of the device resembling for example a tail as how an animal usually carries its prey thereby encouraging frequent use and teeth cleaning. It would then be also be desirable for the device to be light-weight and easy for the animal to manipulate and play with.

It is thus an object of the present technology to address at least some of the inconveniences present in the prior art by providing an improved animal dental hygienic device.

The present technology was created with the foregoing information in mind.

### SUMMARY

In a broad aspect, the present document discloses an animal hygienic device for interaction with teeth, the device comprising: at least one body being elongated; a first surface being an exterior of the at least one body; a second surface being an interior of the at least one body and defining a first cavity for insertion of a first material; a first plurality of interstitial spaces formed by intersection of the first and second surfaces, the first plurality of interstitial spaces providing an active surface and being dimensioned to allow frictional engagement with at least one animal tooth; a container being connected to the at least one body; a third surface being an exterior of the container; and a fourth surface being an interior of the container and defining a second cavity for insertion of a second material.

In some embodiments, the device further comprises a second plurality of interstitial spaces distributed on the container, the second plurality of interstitial spaces providing an additional active surface and being dimensioned to allow frictional engagement with at least one animal tooth.

In some embodiments, the device further comprises a second plurality of interstitial spaces distributed on the container, the second plurality of interstitial spaces providing an additional active surface and being dimensioned to allow frictional engagement with at least one animal tooth.

In some embodiments, one or more of the surfaces is composed of a set of portions.

In some embodiments, each portion is selected from the group consisting of a string, a cord, a yarn, a wire, an elastic band, a lace, a thin ribbon, a thick ribbon, a feather and a strand.

In some embodiments, each portion is identical.

In some embodiments, a first set of portions is composed of thin ribbons and a second set of portions is composed of thick ribbons.

In some embodiments, a first set of portions is composed of ribbons and a second set of portions is composed of strands.

In some embodiments, the sets of portions are attached together by at least one of: glueing, braiding, weaving, fusing, chemical bonding, mechanical bonding, sewing, knitting, crocheting, stapling, clipping, pinning and lacing.

In some embodiments, at least part of the set of portions frictionally engage an interdental space of adjacent teeth during the interaction.

In some embodiments, the first surface and the second surface are composed of the sets of portions.

In some embodiments, the set of portions frictionally engage an interdental space of adjacent teeth.

In some embodiments, the container has at least one opening.

In some embodiments, the container has at least two openings, the at least two openings including a first opening for connection with the at least one body and a second opening for insertion or removal of the second material within the second cavity.

In some embodiments, the at least one body forms a connection to the container at the first opening.

In some embodiments, the at least one body is removably connected to the container.

In some embodiments, the first cavity contains a first material and wherein the second cavity contains a second material.

In some embodiments, the first material and the second material are selected from the group consisting of: treats, toys, bells, squeakers, a mesh, a plush, sticks, twine, sponge and combinations thereof.

In some embodiments, the device includes a plurality of bodies.

### BRIEF DESCRIPTION OF THE DRAWINGS

For a better understanding of the present technology, as well as other aspects and further features thereof, reference is made to the following description which is to be used in conjunction with the accompanying drawings illustrating embodiments of the present technology, where:

FIG. 1 is a front elevation view of an animal dental hygienic device being a first embodiment;

FIG. 2 is a perspective view of a body that may be used in the animal hygienic device.

FIG. 3 is a front magnified view of a material used in the animal dental hygienic device of FIG. 1, in a first embodiment;

FIG. 3A is a front magnified view of a material used in the animal dental hygienic device of FIG. 1, in a second embodiment;

FIG. 4 is a front magnified view of a material used in the animal dental hygienic device of FIG. 1, in a third embodiment;

FIG. 5 is a front magnified view of a material used in the animal dental hygienic device of FIG. 1, in a fourth embodiment;

FIG. 6 is front magnified view of a material used in the animal dental hygienic device of FIG. 1, in a fifth embodiment;

FIG. 7 is a perspective view of a container that may be to a part of the animal dental hygienic device;

FIG. 8 is a front view of the container of FIG. 7 that has been compressed as to be in a deformed state;

FIG. 9 is a front elevation view illustrating a container attached to a body;

FIG. 10 refers to a front elevation view of an alternative embodiment of the animal dental hygienic device from FIG. 1, having the shape of a prey; and

FIG. 11 refers to a front view of the animal dental hygienic device with an empty container.

### DETAILED DESCRIPTION

Referring to the Figures, there are shown various animal dental hygienic devices of the present technology. It is to be expressly understood that the various animal dental hygienic devices are merely some embodiments of the present technology. Thus, the description thereof that follows is intended to be only a description of illustrative examples of the present technology. This description is not intended to define the scope or set forth the bounds of the present technology. In some cases, what is believed to be helpful examples of modifications to the animal dental hygienic devices may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of embodying that element of the present technology. As a person skilled in the art would understand, variations are possible within the intended scope of the present disclosure. In addition, it is to be understood that the animal dental hygienic devices may provide in certain instances rudimentary embodiments of the present technology, and that where such is the case they have been presented in this manner for purposes of illustrative clarity as an aid to understanding. As persons skilled in the art would understand, various embodiments of the present technology may be of a greater complexity.

The term “surface” should be understood and interpreted broadly as defining a layer or a sheet of material that is encircling or covering a portion. The surface may be planar, polished, or deformed and/or rugous.

FIG. 1 illustrates an animal dental hygienic device 100 having a body 200, a container 600, which is attached with the body using a tie 501, and decorative attachments 701 and 702. Such tie and attachments may be of any form, shape, or material suitable for safe use by an animal as a playful attractant. The animal dental hygienic device 100 is to be used by a toothed animal by interacting with it (e.g., biting, playing, eaten, etc.). The materials used in one or more parts of the device 100 may thus be chosen as to be consumable.

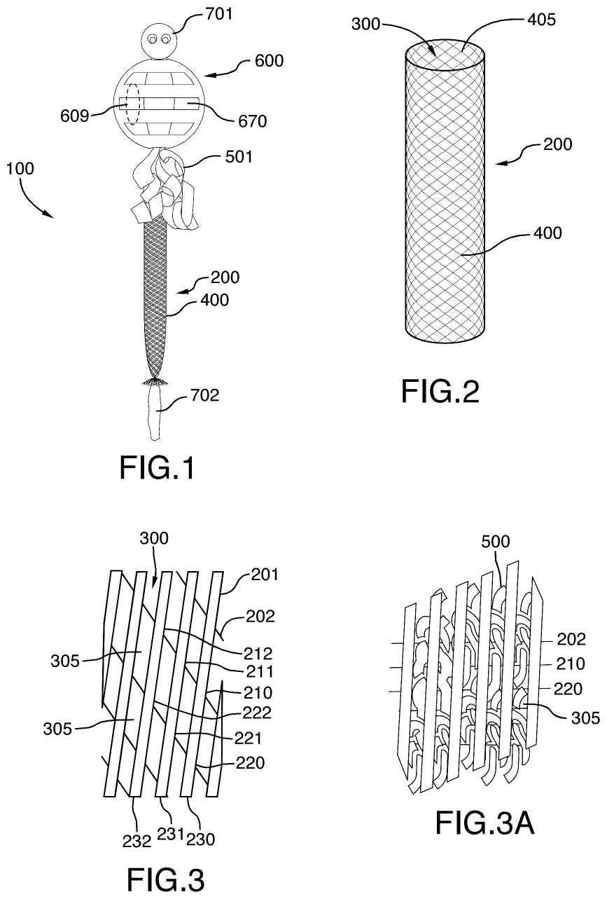

As further shown with regard to FIG. 2, the body 200 has an exterior surface 400 and an interior surface 405, which defines an interior cavity 300 that is at least partially cylindrical. The exterior surface 400 encircles and covers the interior surface 405 and the cavity 300 of the body 200.

In the device 100, the body 200 is attached to the container 600 by using the tie 501. Alternatively, the body 200 may be attached to the container 600 by tying the body 200 itself inside the container 600, or by any other suitable manner of attachment. The container 600 is filled with a treat 609 (shown in dotted lines). The container 600 may also be filled with other filling materials (“filler” 500) that are further detailed below. It should be understood that the treat or other filler may be of any shape or material suitable as an animal attractant whether or not being itself consumable.

A first decorative attachment 701 and a second decorative attachment 702 are respectively present on the container 600 and on the body 200. The first and second decorative attachments 701, 702 may be used to increase the animal's attraction to the device 100. Other decorative attachments may be present on the device 100.

As previously mentioned, FIG. 2 shows the body 200 of the device 100 having the exterior surface 400, the interior surface 405, which defines the interior cavity 300 inside the body 200. The surfaces 400, 405 may be made of various materials (as detailed below) and are represented in FIG. 2 as crossing portions forming interstitial openings (or apertures) 305 located or otherwise formed circumferentially on the body 200. As further described hereinbelow, the crossing portions may be interwoven or otherwise intersecting strands of a variety of shapes and sizes. The body 200 is illustrated as cylindrical but may be of any round or elongated form, such as a tapered cylinder having a variable radius or a cone-liked form or wavy with a sinusoidal shape or the like.

FIGS. 3, 3A, 4, 5 and 6 illustrate different additional embodiments of the surfaces 400, 405 of the body 200. The layered materials illustrated within FIGS. 3, 3A, 4, 5 and 6 may be used in or upon the container 600 and/or in or upon other parts of the device 100 such as the decorative attachments 701, 702 or the tie 501. It should therefore be understood that in all embodiments described herein, the layered materials may be located upon and partially, or completely, cover the container 600 of the device 100 regardless of any specific shape or form of the container 600. Alternatively, the layered materials may partially or wholly form the container 600 of the device 100 regardless of any specific shape or form of the container 600.

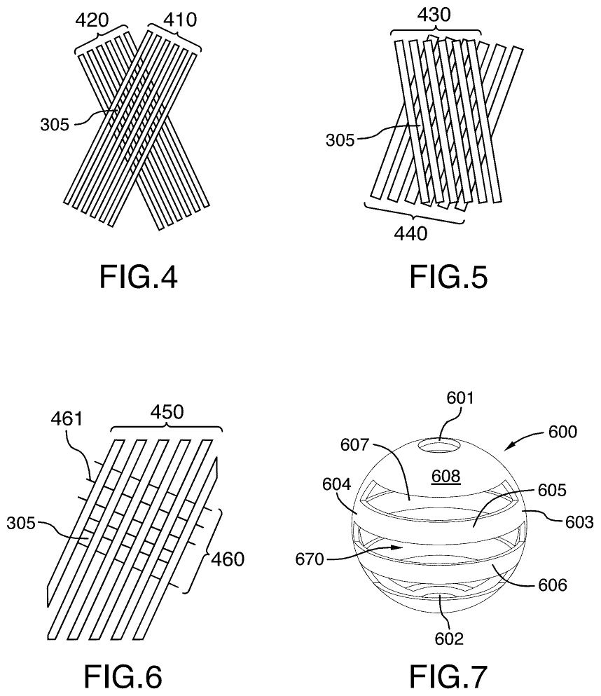

FIG. 3 is an enlarged view of the surfaces 400, 405 of the body 200. The surfaces 400, 405 are composed of sets of portions 450, 460 (as denoted in FIG. 4 which is a similar configuration as shown in FIG. 3). In FIG. 3, the sets of portions are ribbons 230, 231, 232 and strands 202, 210, 220. The ribbons 230, 231, 232 are attached or held together by operation of their attachment to the thinner strands 202, 210, 220 which may be in a crossed or weaving manner. For instance, the strands 220 and 222 may be positioned on the upper surface of the ribbons 230 and 232 while the strand 221 may be located under the ribbon 231. The crossing or weaving of the ribbons 230, 231, 232 and strands 202, 210, 220 forms interstitial spaces 305 that define active surfaces, which allow animal teeth penetration and thus cleaning thereof. The active surfaces are the edges of the ribbons and strands which define each interstitial space of which there are numerous interstitial spaces located across the entirety of the body 200. The weaving of the ribbons 230, 231, 232 and strands 202, 210, 220 also allows for a more reinforced body 200 that is both structurally sound and yet allows for slight movements of the portions so as to allow increased and smoother teeth penetration and cleaning. For instance, the active surfaces of adjacent strands 202, 210, 220 and/or ribbons 230, 231, 232 may clean the interdental space of the animal teeth when the animal engages the body 200 with its mouth (e.g., by biting). The portions may also effectively have knifelike edges for scraping the plaque and tartar off an animal's tooth when the animal is engaging the device 100. In FIG. 3, the cavity 300 is empty though the cavity may include a filler 500 material as further detailed below with regard to FIG. 3A.

As described above, it should therefore be understood that the interstitial spaces 305 may preferably be sized and shaped appropriately to fit the size and shape of the intended teeth to be cleaned and may preferably be arranged in a position and sequence thereby maximizing cleaning efficiency balanced by the number and arrangement of the interstitial spaces. The interstitial spaces along with the remaining device structure therefore determines the durability and resistance to tearing or shredding by an animal.

It has to be noted that larger than ideal interstitial spaces 305 structure and dimension would decrease the cleaning efficiency of the dental hygienic device 100 and thus clean less teeth and fewer surfaces of teeth. Contrastingly, interstitial spaces 305 that have smaller dimensions than ideal will not allow the full penetration of the largest teeth therethrough and cause sticking of the device onto the teeth thereby upsetting the animal and restricting repeated chewing. Thus, it should be understood that ideal spacings may differ for the intended subject animal using the present inventive device.

For cats, the interstitial spaces 305 of the device 100 may have active dimensions that correspond to a width of approximately 0.04 in. to 0.16 in. (1 mm to 4 mm); approximately 0.04 in. to 0.08 in. (1 mm to 2 mm); approximately 0.08 in. to 0.16 in. (2 mm to 4 mm); or approximately 0.12 in. to 0.16 in. (3 mm to 4 mm). These dimensions correspond respectively to the incisors, canines, premolars, and molars of cat teeth. Additionally, as the length of cat teeth varies from 0.08 in. to 0.59 in. (2 mm to 15 mm), the body 200 or other parts of the device 100 should be dimensioned to allow at least partial or complete penetration of the cat teeth. Smaller or bigger dimensions of interstitial spaces 305 and device 100 parts may be also be chosen according to other animals or mammals.

The portions 450, 460 may be foil, strings, cords, yarn, wires, elastic bands, laces, feathers, etc. The portions 450, 460 may be of different materials and have different dimensions that are in different forms such as multi-stranded, striated, rigid or flexible. Examples are metal, plastics (including e.g., polyester and bioplastics), cord, mylar, nylon, rubber, graphite, composite, etc. The choice of material, dimensions and configurations may also provide a suitable durability and fitness for use so as to ensure acceptable safe use by an animal. In order to provide safe use by the animal, the materials may be consumable. The portions 450, 460 are not limited to a single material; multiple similar and dissimilar materials may be attached together such as by way of example a thin mylar foil intermeshed with a thin nylon fiber or an elasticized fiber allows efficient scraping of the sides of teeth, specifically the relatively small, conical, needle-shaped teeth as found in cats (“needle-like teeth”). In other instances materials like a thin mylar foil by way of example may be crisscrossed such that a cat's tooth may penetrate between the portions thereby helping to scrape away plaque and immature tartar. As previously mentioned, the portions 450, 460 may preferably be of sufficient hardness and shape to thus enable the corresponding active surfaces to scrape the outer surface of the tooth during frictional engagement to remove dental plaque, yet open enough not to permit sticking of the animal's tooth and restricting opening of the corresponding interstitial space.

In addition of the material used for the portions, a substance may be applied on the portions 450, 460 as a coating thereof and as to provide additional benefits to the device 100 for the animal. For instance, the substance may be prebiotic, postbiotic, toothpaste, or any nutritional or pharmaceutical substances that are compatible with the device 100. The substance may be applied on the portions 450, 460 or incorporated in the portions 450, 460 for a sustained or instant release in or on the mouth of the animal.

The portions 450, 460 may also be attached or otherwise connected together for instance by glueing, braiding, weaving, fusing, chemical bonding, mechanical bonding, sewing, knitting, crocheting, stapling, clipping, pinning or lacing.

FIG. 3A shows an alternative arrangement of ribbons 230, 231, 232 and strands 202, 210, 220, where the ribbons and strands intersect in a similar manner as in FIG. 3 but with a different orientation relative to one another. The ribbons 230, 231, 232 are intersecting the strands 202, 210, 220 in a generally perpendicular orientation, thus forming square-shaped interstitial spaces 305. Other possibilities of configurations of ribbons 230, 231, 232 and strands 202, 210, 220 (or generally speaking: intersecting “portions”) are discussed above and may also be applicable here.

One particularity of FIG. 3A is the presence of a filler 500, which is a material introduced in the cavity 300. The filler 500 as shown in FIG. 3A is a porous material into which the animal tooth may be inserted (e.g., via biting) when the animal is engaging or otherwise interacting with the device 100. The filler 500 may be an abrasive, sponge or mesh-like structure and may be sprinkled or rubbed onto the portions 450, 460 of the material of the body 200. Alternatively, the filler 500 may also include treats, toys, bells, squeakers, a mesh, a plush, sticks, twine, sponge, nip, or combinations thereof. The filler 500 may thus further assist the overall function of the device so that a animal's tooth may be further cleaned while penetrating therethrough, or further attract the animal for increasing the time of engagement of the animal with the device 100 (for instance when the filler includes a treat).

The cavity 300 and/or the filler 500 material may also be a reservoir for a fluid or a material to exit the device 100 during chewing or biting and flow into the mouth of the animal (without or along with solid particles also being part of the body 200). Examples include toothpastes, mouth rinses, dental medicaments, other medicaments and medications, flavors, animal attractants, nutrients, vitamins, nip, prebiotic, postbiotic, any compatible nutritional or pharmaceutical substances, etc. Almost any biocompatible fluid may be housed within the cavity 300 (as long as it is not incompatible within any other component or material of the device 100). An instant or sustained release of the materials from the reservoir may be provided by sprinkling or rubbing it onto the portions 450, 460.

The filler 500 material may fill the entirety of the cavity 300 of only part of it. Also, the filler 500 material may be a combination of a plurality of different materials. For instance, a treat may be combined with an abrasive foam inside the cavity 300. The filler 300 may also be of the same material as the portions, in the same configuration or in another one, for instance rolled and ball-shaped.

The tie 501 shown in FIG. 1 may also be used to secure the filler 500 in the body 200. The tie 501 may also be pre-attached to the filler 500, which may be covered with an exterior surface 400. Alternatively, the tie 501 may be decorative and enticing to an animal.

Now referring to FIG. 4, a third configuration of sets of portions is illustrated. Two sets of ribbons 410, 420 of similar sizes (that may be considered identical) are attached to one another in a manner as previously discussed with regard to earlier embodiments. As stated above, these two sets of ribbons 410, 420 may be attached or crisscrossed in a manner resulting in square, rectangular, or trapezoidal shaped interstitial spaces. Examples of attachments are provided above and not further repeated here.

FIG. 5 illustrates a fourth configuration of sets of portions 430, 440 that are composed of ribbons of different sized sets. The sets of portions are arranged in a similar manner to FIG. 4 although the ribbons 430 are smaller than the ribbons 440. While one proportion is shown, it should be noted that the sets of ribbons may vary in width relative to the other set in any desired proportion without straying from the intended scope of the invention.

FIG. 6 illustrates a fifth configuration of sets of portions 450, 460. The two sets of portions include strands 460 and ribbons 450 that are crossed in a perpendicular arrangement relative to one another. Compared to FIG. 5, the portions are differently sized and arranged. Each strand 460 may be solid or elastic and are secured to the ribbons 450 in a manner as previously described with regard to earlier embodiments. Other possibilities were described above. Overall, it should be readily apparent that the strands 460 are relatively thin compared to the relatively wider ribbons 450.

As previously seen in FIGS. 3, 3A, 4, 5 and 6 the portions may be fixed, movable, striated, sliding or elastic. It is preferable that the interstitial spaces 305 be equally and circumferentially distributed along the body 200, and not only work in one or two planes, so that the animal's teeth will penetrate at least one interstitial space 305 equally no matter how the animal bites. The inner cavity 300, located within the body 200 and accessible by the animal's teeth, may contain one or more fillers 500 (as previously described) that will further clean, scrape or otherwise abrade away plaque or tarter as the animal carries, bites or chews the device 100. The inner cavity 300 may stay empty or be filled with a substance such as a treat or other agent that will encourage an animal to chew the device or may offer an additional benefit such as dental cleansing, nutritional, or serve as a delivery device for medication, by way of example.

The interstitial spaces 305 may be of any shape sufficient to accomplish their intended function as described hereinabove. For example, in different embodiments, the interstitial spaces 305 will be of one or more of the following shapes: cylindrical, triangular, rectangular, trapezoidal, etc. In some embodiments, all of the interstitial spaces 305 of the device 100 are of the same shape; but this is not required to always be the case. In some embodiments, different interstitial spaces 305 of the same device 100 may have different shapes. The interstitial spaces 305 may be arranged to simultaneously clean the maximum surfaces of teeth of an animal and maximize the mass of remaining structure in order to maximize durability of the device 100.

FIG. 7 illustrates a container 600 having two openings 601 and 602 which are dimensioned for engagement of the body 200 and thus facilitate insertion of a body 200 therethrough. The container 600 has an external surface 608 and an internal surface 607 that defines a cavity 670. The container 600 has vertical extensions 603 and 604 and horizontal extensions 605 and 606. The cavity 670 of the container 600 may be filled with a treat 609 (shown in FIG. 1) or with other filling materials, such as a filler 500 that may be similar to those discussed for FIGS. 3, 3A, 4, 5 and 6. An instant or sustained release of the materials from the container 600 may be provided by sprinkling or rubbing it to the internal surface 607, or by shaking the container 600 when the animal interacts with it.

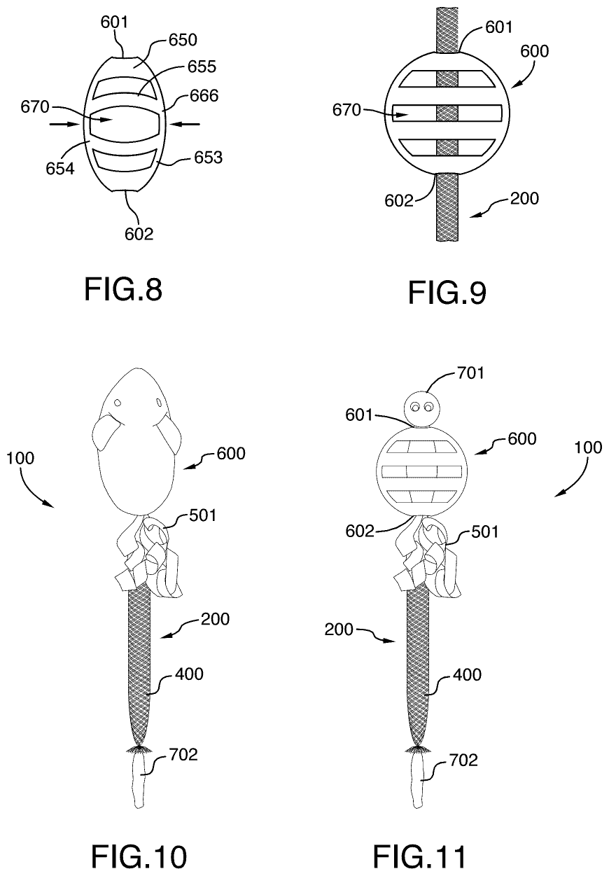

FIG. 8 illustrates a deformed container 650 that correspond to the container 600 from FIG. 6 when external pressure (indicated by opposing unnumbered opposing horizontal arrows) is applied thereon. The deformation may be done by squeezing both vertical extensions 653 and 654 simultaneously which opens a space or otherwise enlarges the gap between the horizontal extensions 666 and 655. The deformed container 650 allows the withdrawal of a used filler and/or the insertion of a new filler 500 material in the cavity 670 between the horizontal extensions 666 and 654. The filler 500 may be various materials, as previously described. Following the insertion of the filler 500, the external pressure on the vertical extensions 653 and 654 is released and the horizontal extensions 666 and 655 spring back thereby closing the space between the horizontal extensions 666 and 655 and thus securing the filler 500 within the cavity 670 of the container 600. It should therefore be understood that the container 650 itself may be fabricated from a relatively flexible yet springy material such as, but not limited to, a polymer or rubber material.

FIG. 9 illustrates a body 200 of the device 100 inserted through the upper opening 601 and the inferior opening 602 of the container 600 by passing through the cavity 670. The body 200 is attached to the container 600 by friction grip. Other types of attachments such as interference fit or by using glue or fixation by a knot 501 (see FIG. 1) are also possible. As stated above, the container 600 includes openings 601, 602 that are dimensioned for engagement of the body 200. The body 200 may pass through one or two openings so as to be connected to the container 600. Also, the body 200 may pass through one or both of the openings 601, 602 and securely connect to the container 600, e.g., by using a tie 501 as described in FIG. 1, by tying the body 200 itself inside the container 600, or by other suitable manner of attachment.

In alternative embodiments, the container 600 may include only one opening 601 and the body 200 is secured inside the opening using any manner of suitable attachment such as glue, a knot 501, by knotting itself or using a body 200 with anchoring wings, barbs or similar mechanisms. In other alternative embodiments, the container 600 may include a plurality of openings 601, 602 and the body 200 is secured by passing through at least three openings 601, 602 as to be connected to the container 600. For instance, the body 200 may pass through three openings and be secured inside the opening using any suitable manner of attachment such as glue, a knot 501, by knotting itself or using a body 200 with anchoring wings or barbs or similar mechanisms. The body 200 may also pass through four openings and be secured as described above.

FIG. 10 illustrates an alternative embodiment of the device 100 from FIG. 1, where the container 600 is of the form of the body of a prey (mouse). The addition of the natural prey-looking container 600 increases stimulation and engagement of the animal towards the device 100. As well as it is described above, the container 600 may be filled with a filler 500 that is identical to the filler 500 in the body 200 or different from the latter. Non-limiting examples or filling materials are detailed above. It should, of course, be readily apparent that the container may take any suitable form, shape, or fantastical creature not limited to a mouse as shown.

FIG. 11 illustrates an alternative embodiment of the device 100 from FIG. 1. In FIG. 11, the container 600 is free from filler 500 material or treat 609 which may be a configuration as of the device as initially provided in commerce—i.e., devoid of any filler or consumable treat.

An exemplary method of assembly of the device 100 from FIG. 1 is described hereinbelow. First, a container 600 may be filled with a filler 500 by deforming the container 600 as described for FIG. 8. A body 200 may also be filled with a filler 500 material and closed. The filler 500 material of the container 600 may be the same or different from the filler 50 material in the body. Alternatively, the body 200 and/or the container 600 may be free from a filler 500 material. After, the body 200 and the container 600 may be connected together with the tie 501 or by different other manners such as glueing, braiding, weaving, fusing, chemical bonding, mechanical bonding, sewing, knitting, crocheting, stapling, clipping, pinning and lacing. After the body 200 is attached to the container 600, other elements such as other bodies 200 or decorative attachments 701, 702 may be added to the device 100. The device would thereafter be ready to use with an animal.

In some embodiments, the body 200 is removably attached to the container 600 so as to allow replacement of either the body 200 and/or the container 600. For instance, if a different body 200 is desired on the dental hygienic device 100. Indeed, in commerce, the body may be provided with one or more containers or vice versa.

In other embodiments, at least two bodies 200 are attached to the container 600. In other embodiments, a plurality of bodies 200 are attached to the container 600 to form, for example, an octopus-like dental hygienic device 100. The bodies 600 may be removable as well. In this case and if the bodies 200 are removably attached to the container 600, the assembler of the device 100 may choose a variety of bodies 200 comprising different cleaning characteristics and different fillers that may be desirable for a certain type or breeds of animals. Additionally, changing the bodies 200 enables changing the type of treats and helps maintain the device's high attractiveness to the animal over time.

The device 100 provides an enhanced cleaning compared to the devices or foods in the prior art. This enhanced cleaning may be caused by the different parts and materials thereof. As an example, the body 200 enables the animal to clean specific areas of the teeth which would be only partially cleaned by the container 600, and vice versa. Specifically, the different parts of the dental hygienic device 100 (e.g., the body 200, the container 600 and the filler material(s) 500) may operate in a coordinated manner for a improved teeth cleaning. For instance, the body 200 cleans the interdental spaces when at least part of the portions are gliding between the dental contact points (interdental spaces), while the container 600 cleans the tooth surfaces of the teeth through frictional action to remove at least partially plaque. This coordinated manner may work in the reverse order and/or using other parts of the dental hygienic device 100 as well (such as the decorative attachments 701, 702, and/or the tie 501).

In an exemplary practical situation, the animal first plays with the container 600 of the device 100 and then bite the container 600. After this first interaction, the animal may bite the body 200 of the device 100 to move the device 100 in another location. In this situation, the device 100 may be configured so as to have a filler 500 in the container 600 that includes hard material for a gross scraping of the teeth. The device 100 may also be configured to have a filler 500 in the body 200 that allows a finer cleaning, such as for the interdental space of the teeth or for the part that is closer to the gum. This two-step cleaning (or coordinated effect) using different parts of the device 100 may provide an enhanced cleaning compared to the prior art.

When the animal bites the body 200, the teeth of the animal penetrate the outer and inner surfaces 400, 405 of the body 200 of the device 100 thereby cleaning its own teeth. Thus no human intervention is needed for the animal to avail itself to the dental hygienic features of the device. During such penetration, plaque, tartar and debris are cleaned from the animal's teeth surface by mere action of the tooth being scraped against the portions of the body 200 and eventually against the filler 500 of the body 200. The more force the animal exerts while biting the device 100, the deeper its teeth will penetrate in the interstitial spaces, thus cleaning the tooth closer to the animal's gum line and potentially cleaning the gingival cavity itself.

While most embodiments of the device of the present technology are intended for use by domestic animals and may be optimized for feline teeth, embodiments of the device may be constructed for use by other animals such as humans, feral animals or wild animals.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. An animal hygienic device for interaction with teeth, the device comprising:
at least one body being elongated;
a first surface being an exterior of the at least one body;
a second surface being an interior of the at least one body and defining a first cavity for insertion of a first material;
a first plurality of interstitial spaces formed by intersection of the first and second surfaces, the first plurality of interstitial spaces providing an active surface and being dimensioned to allow frictional engagement with at least one animal tooth;
a container being connected to the at least one body;
a third surface being an exterior of the container; and
a fourth surface being an interior of the container and defining a second cavity for insertion of a second material.

2. The device as claimed in claim 1, further comprising a second plurality of interstitial spaces distributed on the container, the second plurality of interstitial spaces providing an additional active surface and being dimensioned to allow frictional engagement with at least one animal tooth.

3. The device as claimed in claim 1, wherein one or more of the surfaces is composed of a set of portions.

4. The device as claimed in claim 3, wherein each portion is selected from the group consisting of a string, a cord, a yarn, a wire, an elastic band, a lace, a thin ribbon, a thick ribbon, a feather and a strand.

5. The device as claimed in claim 4, wherein each portion is identical.

6. The device as claimed in claim 3, wherein a first set of portions is composed of thin ribbons and a second set of portions is composed of thick ribbons.

7. The device as claimed in claim 3, wherein a first set of portions is composed of ribbons and a second set of portions is composed of strands.

8. The device as claimed in claim 3, wherein the sets of portions are attached together by at least one of: glueing, braiding, weaving, fusing, chemical bonding, mechanical bonding, sewing, knitting, crocheting, stapling, clipping, pinning and lacing.

9. The device as claimed in claim 3, wherein at least part of the set of portions frictionally engage an interdental space of adjacent teeth during the interaction.

10. The device as claimed in claim 3, wherein the first surface and the second surface are composed of the sets of portions.

11. The device as claimed in claim 3, wherein the set of portions frictionally engage an interdental space of adjacent teeth.

12. The device as claimed in claim 1, wherein the container has at least one opening.

13. The device as claimed in claim 12, wherein the container has at least two openings the at least two openings including a first opening for connection with the at least one body and a second opening for insertion or removal of the second material within the second cavity.

14. The device as claimed in claim 13, wherein the at least one body forms a connection to the container at the first opening.

15. The device as claimed in claim 1, wherein the at least one body is removably connected to the container.

16. The device as claimed in claim 1, wherein the first cavity contains a first material and wherein the second cavity contains a second material.

17. The device as claimed in claim 16, wherein the first material and the second material are selected from the group consisting of: treats, toys, bells, squeakers, a mesh, a plush, sticks, twine, sponge and combinations thereof.

18. The device as claimed in claim 17, wherein the first material differs from the second material.

19. The device as claimed in claim 1, including a plurality of bodies.

20. The device as claimed in claim 19, wherein at least one body includes a filler material unique to the plurality of bodies.
